(19) United States
(12) Patent Application Publication
(10) Pub. No.: US 2009/0053026 A1
(43) Pub. Date: Feb. 26, 2009

(54) Dual conveyor apparatus

(76) Inventors: Kevin J. Pierce, Grand Forks, ND (US); Michael J. Pierce, Grand Forks, ND (US); Randy Dufault, East Grand Forks, MN (US)

Correspondence Address: ROBERT E. KLEVE, 1103-24TH AVE S., GRAND FORKS, ND, 58201, US

(21) Appl. No.: 11/894,981

(22) Filed: Aug. 22, 2007

(51) Int. Cl. B60P 1/36

(52) U.S. Cl. 414/503

(57) ABSTRACT

A dump trailer having a box for storing material therein, a first conveyor for conveying the material out of the forward end of the box, a second conveyor pivot able from a storage position beside the box to a position across the front end of the first conveyor for receiving material from the first conveyor. Said second conveyor being pivotal at an angle for transporting material from the first conveyor at different heights to another object at different heights. Said second conveyor being slidable along its length to different locations on either side of the box.

This invention relates to dump trailers, more particularly this invention relates to dump trailers having dual conveyors. This invention is also related to an earlier issued U.S. Pat. No. 6,283,697.

It is an object of the invention to provide a dump trailer wherein the first conveyor conveys the material out the forward end of the box and the other conveyor pivots from a storage position to a position across the front of the first conveyor and said first conveyor gear driven from side to side along the front of the first conveyor.

It is another object to provide an improved dual conveyor apparatus having an improved drive and positioning apparatus for a moveable conveyor.

Further objects and advantages of the invention will become apparent as the description proceeds and when taken in conjunction with the accompanying drawings wherein:

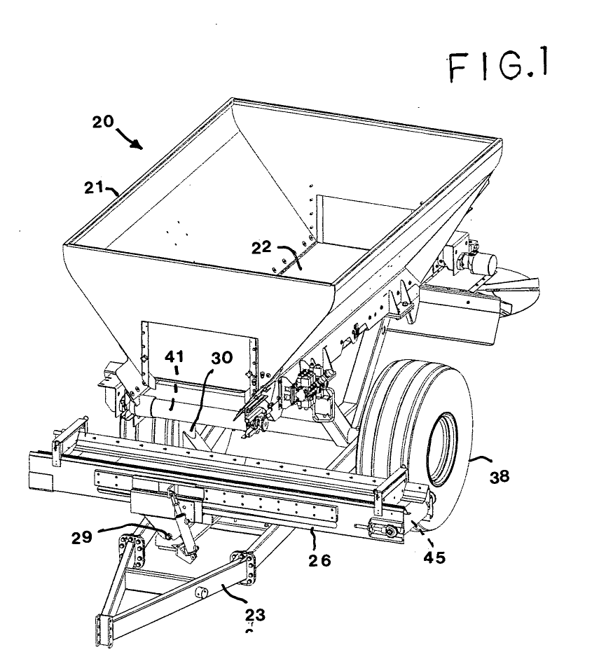

FIG. 1 is a front perspective view of the dual conveyor apparatus with the movable conveyor pivoted in front of the bin conveyor and with the movable conveyor in a horizontal position relative to the bin conveyor.

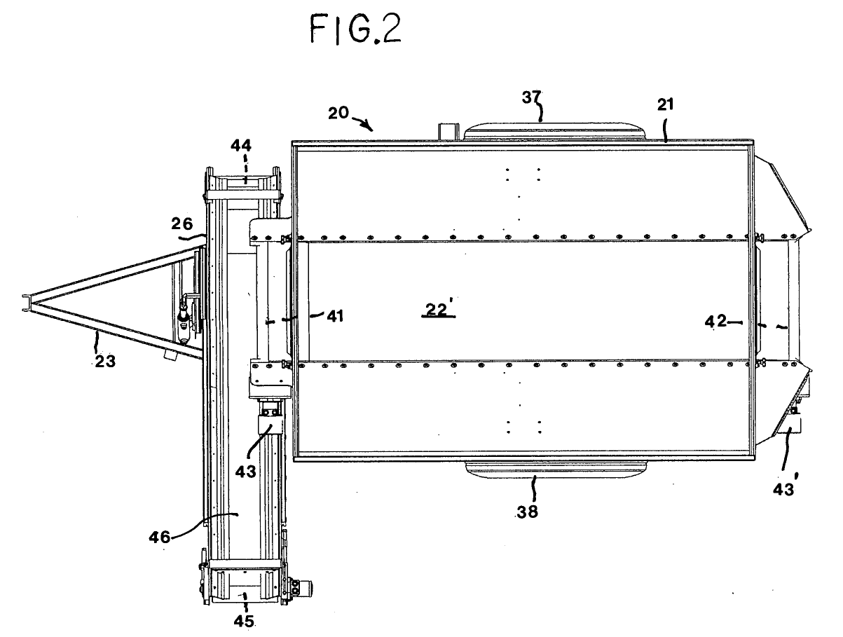

FIG. 2 is a top view of the dual conveyor apparatus with the movable conveyor in front of the bin conveyor in a horizontal position relative to the bin conveyor.

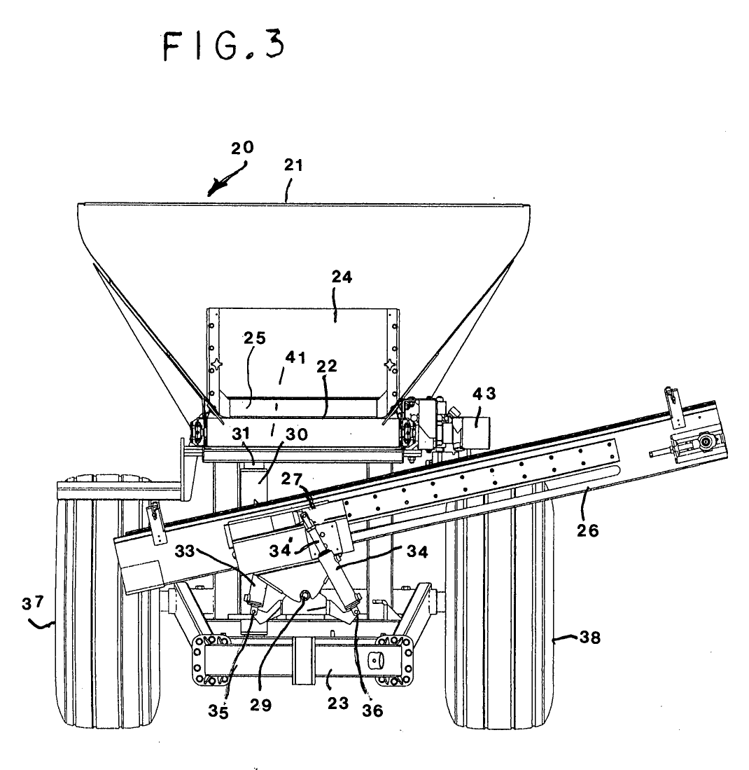

FIG. 3 is a right side elevational view of the dual conveyor with the movable conveyor pivoted to the front of the bin conveyor and with the movable conveyor tilted at a upward angle relative to the bin conveyor.

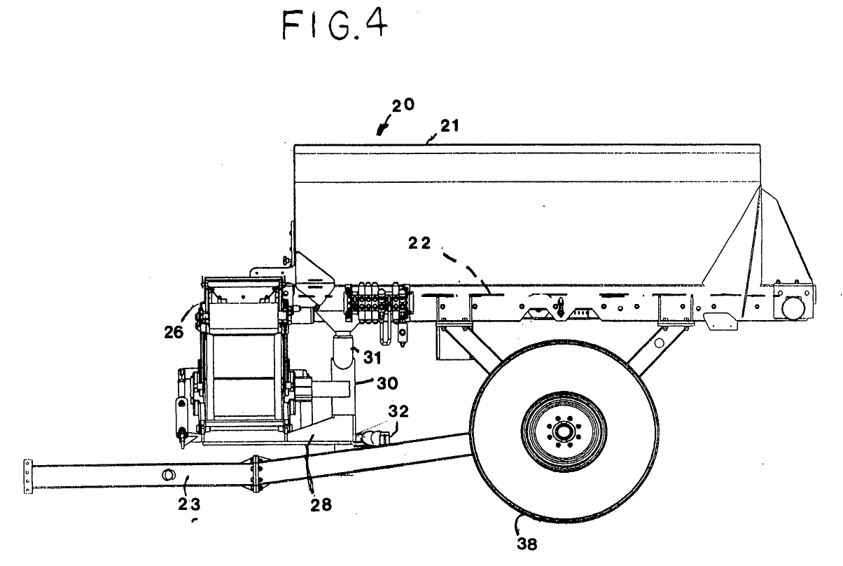

FIG. 4 is a left side elevational view with the movable conveyor in front of the bin conveyor at a upward angle relative to the bin conveyor.

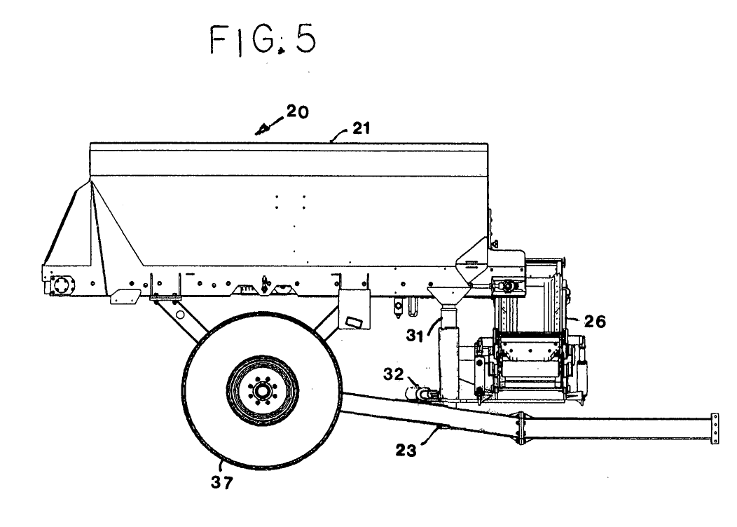

FIG. 5 is a front elevational view of the dual conveyor apparatus with the movable conveyor in front of the bin conveyor and at an upward angle relative to the bin conveyor.

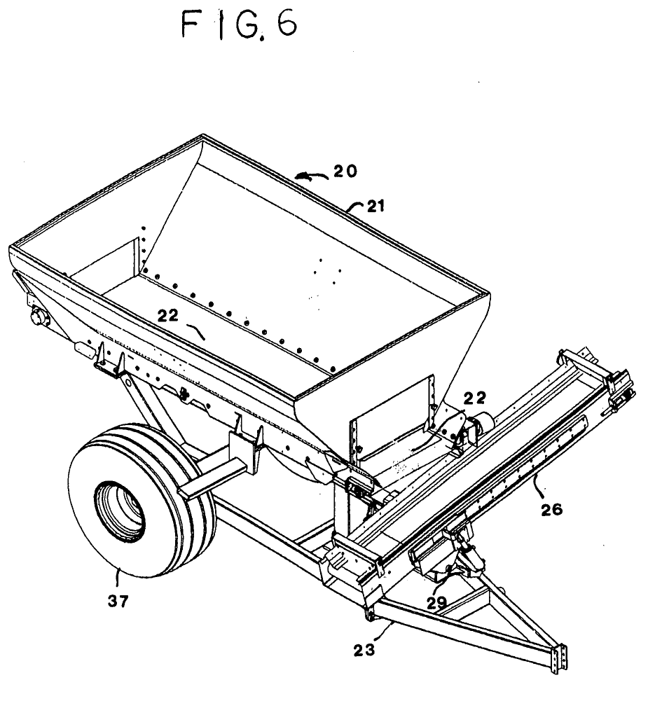

FIG. 6 is a right front perspective view of the dual conveyor apparatus with the movable conveyor in front of the bin conveyor at an upward angle relative to the bin conveyor.

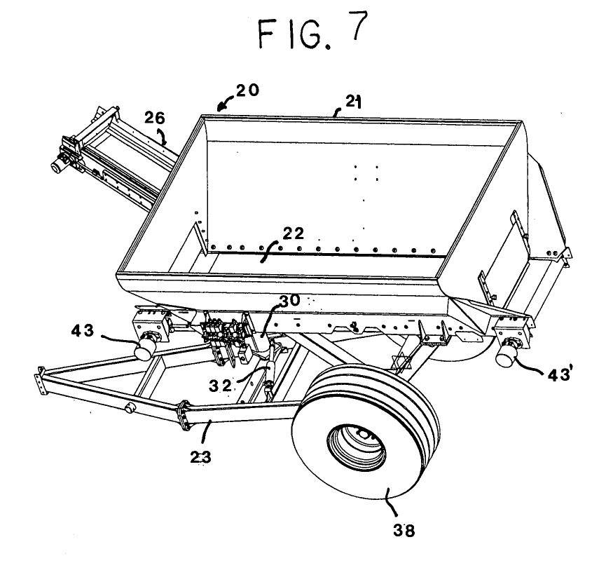

FIG. 7 is a left front perspective view of the dual conveyor apparatus with the movable conveyor pivoted to a position beside the bin conveyor in the storage position.

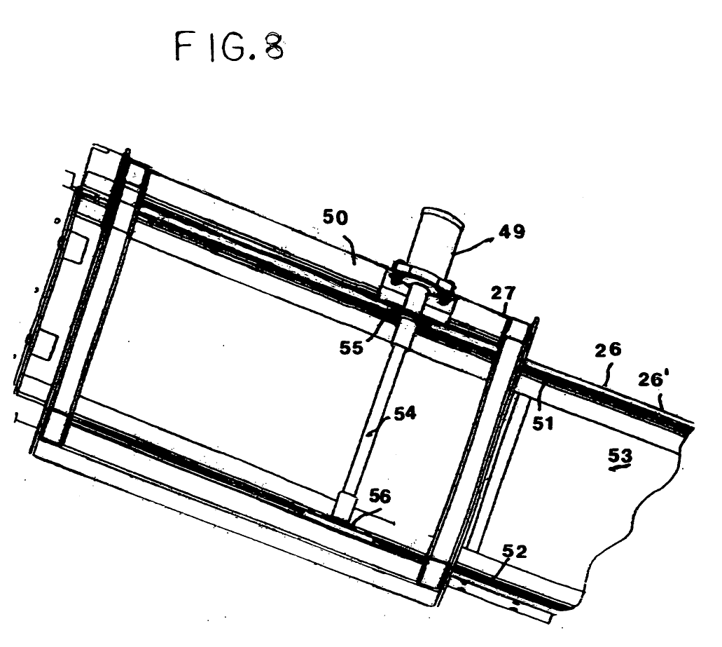

FIG. 8 is a cross sectional view of the gear drive or the second conveyor in the channel taken along line 8-8 of FIG. 3.

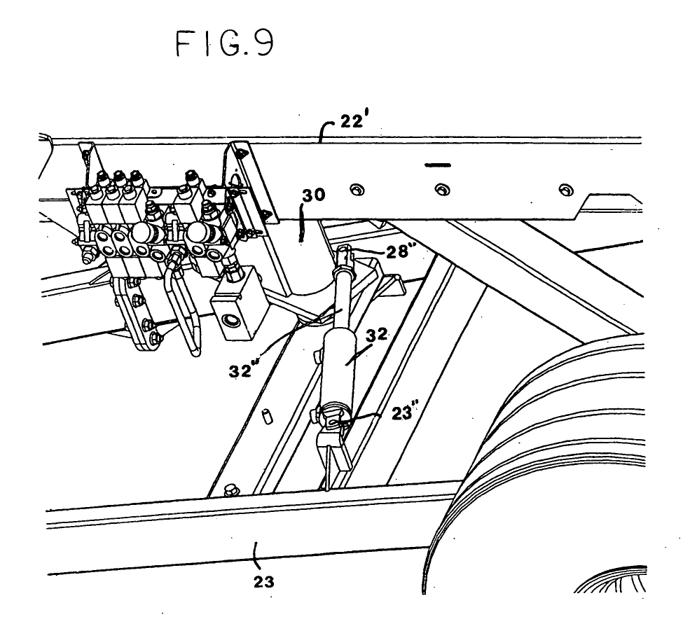

FIG. 9 is an enlarged view FIG. 7 illustrating the hydraulic cylinder connection to the pivotal mounting of the second conveyor.

Briefly stated the invention comprises a dual conveyor apparatus having a pair of conveyors with the first conveyor mounted beneath the storage bin for emptying material out of one end of the bin. A second conveyor is pivotally mounted to the one end of the bin to pivot from a storage position beside the bin to a position in front of the bin. The second conveyor has means to move longitudinally across the front of the one end of the bin and has means to pivot upward to an angle relative to the bin.

Referring more particularly to the drawings the dual conveyor apparatus 20 has a bin 21 and a first conveyor 22 mounted beneath the open bottom 21′ of the bin. The bin and first conveyor are mounted to a main frame 23 by diagonal beams 23′ between the bin and the frame 23 at the rear of the bin. The bin has a slidable door 24 mounted across the front opening 25 in the bin 21 and is adjustable to different heights to vary the size of the opening by knob means 24′.

A second conveyor 26 is slidably mounted on a channel member 27. The channel 27 is pivotally mounted to an adjustment mechanism 28 at pivot point 29. The adjustment mechanism 28 has a base plate 28′ beneath the adjustment mechanism and fixed thereto. The base plate 28′ has a sleeve 30 has a projecting arm fixed to the plate at one end and fixed to the sleeve 30 at the other end and the sleeve surrounds a post 31. The post 31 is fixed beneath the bin 21 and between the bin and the frame 23 and provides a forward support for the bin.

The pivotal mounting of the sleeve to the post 31 also enables the adjustment mechanism 28 and the channel 27 and the second conveyor 26 to pivot about the post 31 from a storage position beside the bin 21 to a position in front of the first conveyor 22 as shown in FIG. 1.

A hydraulic cylinder 32 is pivotally mounted between the plate of the adjustment mechanism 28 and the frame 23 to pivot the adjustment mechanism 28 along with the channel 27 and the second conveyor 26 from a storage position and a position across one end of the first conveyor 22.

The piston 32′ of the hydraulic cylinder is pivotally mounted to the plate 28′ at pivot 28″. The cylinder 32 is pivotally mounted to the frame 23 at pivot point 23″ so that actuation of the cylinder acts to pivot plate 28′ relative to the main frame 23.

The channel 27, along with the second conveyor 26, may be pivoted at an angle from its horizontal position shown in FIG. 1 to an angular position such as shown in FIGS. 4 and 5 by a pair of hydraulic cylinders 33 and 34. The hydraulic cylinder 33 has its cylinder 33′ pivotally mounted to the adjustment mechanism 28 at pivot point 35 with the piston 33″ pivotally mounted to the channel 27 at pivot point 35′. The hydraulic cylinder 34 has a cylinder portion 34′ mounted to the adjustment mechanism at pivot point 36 and the piston portion 34″ pivotally mounted to the channel 27 at pivot point 36′.

The cylinders 33 and 34 are mounted in opposing relation with respect to the pivot point 29 so that retracting piston 33″ when viewed from FIG. 5 while projecting piston 34″ will act in harmony or unison to pivot the channel 27 and second conveyor 26 upward in a counter clockwise direction to its position as shown in FIG. 1 to its position shown in FIG. 5. Conversely retracting piston 34″ and projecting piston 33″ will pivot the channel 27 about pivot 29 in a clockwise direction when viewed from FIG. 5.

The frame 23 has a pair of wheels 37 and 38 to rotatably support the main frame 23. The main frame is provided with attachment means 39 of the forward end of the frame 23 for towing the apparatus from place to place. The post 31 is fixed between the bin 21 and the main frame 23 for supporting the front of the bin. The bin 21 has a rear door panel 40 for closing the rear bin over the rear portion of the first conveyor 22. The first conveyor has a roller 41 at its forward end and a roller 42 at its rearward end rotatably supporting the elongated first conveyor belt 22′. A pair of motors 43 and 43′ are mounted to the front and rear rollers 41 and 42 respectively for driving the first conveyor belt 22′.

The second conveyor 26 has two rollers 44 and 45 at each end of the frame 26′ to rotatively support the second conveyor belt 46. A second conveyor motor 47 is reversible for driving the roller 44 in either direction clockwise or counterclockwise for rotating the second conveyor belt 46 about the rollers 44 and 45 in either direction.

The channel 27, as viewed from FIG. 8 has a drive motor 49 mounted to the rear panel 50 of the channel 27. The conveyor frame 26′ has pair of tracks 51 and 52 extending along the length of the bottom 53 of the conveyor frame 26′.

The channel frame 26′ also has a drive shaft 54 extending from the motor 49 laterally across the bottom of the channel frame 26′ with drive or spur gears 55 and 56 fixed on the shaft in spaced relation on the shaft to engage the tracks 51 and 52 of the conveyor frame 26′, respectively.

Consequently, activating the drive motor 49 on the conveyor frame in one direction will drive the gears 55 and 56 in one direction to drive the conveyor frame in one direction across the front end of the first conveyor and activating the drive motor 49 in the opposite direction will drive the gears 55 and 56 in the opposite direction which will drive the second conveyor frame in the opposite across the front of the first conveyor.

In operation the second conveyor will be pivoted from its storage position to a position in front of the first conveyor as shown in FIGS. 1 and 2. The second conveyor when in front of the first conveyor as shown in these figures can now be tilted from its normal horizontal position such as shown in FIG. 2 to a tilted angular position as shown in FIG. 3 to different angular positions as shown in FIGS. 3, 5 and 6 by actuation in retracting of the piston 33′ and telescoping of piston 34′ which acts to pivot the channel and the second conveyor 26 about pivot 29. Conversely retracting piston 34′ and telescoping piston 33′ will act to pivot the channel and the second conveyor about 29 in the opposite direction.

It will be obvious that various changes and departures may be made to the invention without departing from its spirit and scope thereof and accordingly is not intended that the invention be limited to that specifically described in the specification or as illustrated in the drawings but only as set forth in the appended claims wherein:

1. Dual conveyor dump trailer comprising a bin, a first conveyor, a second conveyor, said first conveyor being mounted along the bottom of said bin with one end projecting forward, said bin having an open bottom so that powering the first conveyor may move material from the bin along the conveyor and out the forward end of the bin, said second conveyor having a first pivotal means pivotally mounted along a vertical axis to the bin to pivot said second conveyor from a storage position beside the bin to a position across the one end of the first conveyor, said second conveyor having a channel pivotally mounted to said first pivot means for supporting said second conveyor about a horizontal axis, hydraulic means connected between said channel and supporting means whereby said channel and second conveyor may be tilted at an angle about said horizontal pivot, drive means on said channel for driving said second conveyor longitudinally to one side or the other of the bin.

2. Dual conveyor dump trailer comprising a bin, a first elongated conveyor, a second elongated conveyor, said first conveyor being mounted along the bottom of said bin with one end projecting forward, said bin having an open bottom so that powering the first conveyor may move material from the bin along the conveyor and out the forward end of the bin, said second conveyor having support means movably mounted along a vertical axis to the bin to move from a storage position beside the bin to a position across the one end of the first conveyor, said second conveyor having a channel mounted on said support means for pivotally supporting said second conveyor about said a horizontal axis to the bin, means connected between said channel
and supporting means whereby said channel and second conveyor may be tilted at an angle about said horizontal pivot relative to said support means, drive means on said channel for driving said second conveyor longitudinally along said channel to one side or the other of the bin.

3. A dual conveyor dump trailer according to claim 1 wherein said second conveyor is slidable mounted to said channel, motor means are provided on said channel, gear means mounted to said channel to engage said second conveyor, said motor means being connected to said gear means whereby powering said motor will drive said gear means, with said gear means driving said second conveyor to move said conveyor to one end or the other end of said channel.

4. A dual conveyor dump trailer according to claim 3 wherein said first pivotal means comprises a sleeve, said bin having a vertical post beneath the bin with said sleeve surrounding said post to provide said first pivotal means.

5. A dual conveyor dump trailer according to claim 2 wherein hydraulic cylinder means are provided between said channel and said supporting means for powering said pivoting of said channel and of said second conveyor to the angular position.

6. A dual conveyor dump trailer comprising a bin, a first conveyor, a second conveyor, said first conveyor being mounted along the bottom of said bin with one end projecting forward, said bin having an open bottom so that powering the first conveyor may move material from the bin along the conveyor and out the forward end of the bin, a support structure for said second conveyor, said support structure having a sleeve, a trailer having a frame beneath said bin, said post mounted on said frame upright beneath said bin, said sleeve being rotatively mounted to said post, said support structure having a channel pivotally mounted to said support structure, said second conveyor having a conveyor frame slidably mounted in said channel with a conveyor belt mounted on said conveyor frame, said support structure being pivotal about said sleeve connection to said post to pivot said channel, said second conveyor frame, said second conveyor belt from a position beside said bin to a position in front of the first conveyor so that material may be carried by said first conveyor out of said bin on to said second conveyor belt and said second conveyor belt may be tilted at an angle to vary the position of the ends of the second conveyor belt to different heights so that the second conveyor belt may convey material to the bin off the second conveyor belt at different heights from one end or the other.
